(19) United States
(12) Patent Application Publication
(10) Pub. No.: US 2021/0099798 A1
(43) Pub. Date: Apr. 1, 2021

(54) ACTIVE NOISE EQUALIZATION APPARATUS AND METHOD

(71) Applicants: Katholieke Universiteit Leuven, K.U.Leuven R&D, Leuven (BE); Universitat Politecnica de Valencia, Valencia (ES)

(72) Inventors: Marc Moonen, Leuven (BE); Amin Hassani, Leuven (BE); Alberto González Salvador, Valencia (ES); María de Diego Antón, Valencia (ES); Miguel Ferrer Contreras, Valencia (ES); María Gemma Piñero Sipán, Valencia (ES)

(21) Appl. No.: 16/995,626

(22) Filed: Aug. 17, 2020

Related U.S. Application Data
(60) Provisional application No. 62/908,483, filed on Sep. 30, 2019.

(51) Int. Cl. H04R 3/04; H04B 1/10; H04B 15/00

(52) U.S. Cl. CPC H04R 3/04; H04B 15/00; H04B 1/10

(57) ABSTRACT

A method of active noise equalization in a system comprising a plurality of nodes is disclosed, wherein each node comprises at least one acoustic sensor and at least one acoustic actuator, and each node has an associated target spectral noise profile and an associated set of adaptive filter coefficients. The method comprises the steps of: i) at each node, receiving a reference acoustic signal; ii) at each node, generating an output acoustic signal based on the received reference acoustic signal and the associated set of adaptive filter coefficients for the node; iii) at each node, receiving a measured acoustic signal for the node and computing a pseudo-error signal for the node in dependence upon the received measured acoustic signal and the target spectral noise profile associated with the node; and iv) updating at least one adaptive filter coefficient in the set of adaptive filter coefficients for at least a first node comprised in the plurality of nodes, in dependence upon the pseudo-error signal associated with the first node, the reference acoustic signal, and at least one parameter received from at least one other node in the plurality of nodes which is dependent on the pseudo-error signal associated with the at least one other node.

### CROSS-REFERENCE TO RELATED APPLICATION

This application claims the benefit under 35 U.S.C. § 119(e) of U.S. Provisional Patent Application Ser. No. 62/908,483, filed Sep. 30, 2019, the disclosure of which is hereby incorporated herein in its entirety by this reference.

### TECHNICAL FIELD

This application relates to methods and apparatus for active noise equalization.

### BACKGROUND

Background noise inside aircraft, in vehicles such as cars, and in noisy environments such as dwellings subject to traffic noise produces most common social problems involving noise. Such noise, beside bringing psychological problems that increase the costs to the healthcare systems, can disrupt communication between people and can require desired audio signals such as music, audio announcements, TV signals, to be amplified in order to be heard over the background noise. This amplification can cause further discomfort and inconvenience.

One existing solution is to use one-per-user active noise control (“ANC”) headphones to effectively suppress the background noise. However, this is not comfortable and in some cases not allowed (e.g., for the driver of a vehicle).

One problem with existing methods of headphone-less active noise cancellation using microphones and loudspeakers embedded in, for example, the headrest of a seat, is that noise cancellation signals output by a loudspeaker for one seat (or location) can interfere with noise cancellation signals for another seat (or location).

“Multichannel active noise equalization of interior noise,” A. Gonzalez et al., IEEE Transactions on Audio, Speech, and Language Processing (Volume: 14, Issue: 1, Jan. 2006), describes a multiple frequency active noise equalization method, wherein the same noise profile is produced at different locations.

### BRIEF SUMMARY

Provided is a method of active noise equalization, which allows for different output acoustic signals to be provided at different locations, or nodes. This can be achieved with a reference signal that is common to each location.

According to a first aspect, there is provided a method of active noise equalization in a system comprising a plurality of nodes, each node comprising at least one acoustic sensor and at least one acoustic actuator, and each node having an associated target spectral noise profile and an associated set of adaptive filter coefficients, the method comprising the steps of:
i) at each node, receiving a reference acoustic signal;
ii) at each node, generating an output acoustic signal based on the received reference acoustic signal and the associated set of adaptive filter coefficients for the node;
iii) at each node, receiving a measured acoustic signal for the node and computing a pseudo-error signal for the node in dependence upon the received measured acoustic signal and the target spectral noise profile associated with the node; and
iv) updating at least one adaptive filter coefficient in the set of adaptive filter coefficients for at least a first node comprised in the plurality of nodes, in dependence upon the pseudo-error signal associated with the first node, the reference acoustic signal, and at least one parameter received from at least one other node in the plurality of nodes which is dependent on the pseudo-error signal associated with the at least one other node.

The method may include repeating at least steps ii) to iv). The method may comprise repeating steps i) to iv).

By determining a pseudo-error signal specific to each node, the method allows a different output spectral noise profile to be specified at each node. This allows users to choose their own noise profile regardless of what other users in the vicinity have chosen. For example, a passenger and a driver in a car can listen to the same music track while the driver also receives audio instructions from a navigation system, which the passenger does not hear. A passenger in the rear seat of a car may want to completely cancel the background noise whereas the driver might want to adjust the noise profile to be sure that the car system is running properly. In another example concerning two adjacent passengers in an airplane, one may be watching a film and wish to reduce the background noise as low as possible while the other can choose a custom white noise profile suitable for relaxing.

Receiving a reference acoustic signal may comprise receiving the reference acoustic signal at the first node, and determining at least one adaptive filter coefficient for at least the first node may comprise receiving, at the first node, the at least one parameter dependent on the pseudo-error signal associated with at least one other node comprised in the plurality of nodes and determining, at the first node, the at least one adaptive filter parameter for the first node.

The method may comprise sending, from the first node, at least one parameter dependent on the pseudo-error signal associated with the first node to at least one other node comprised in the plurality of nodes.

The at least one parameter dependent on the pseudo-error signal associated with a node may comprise at least one adaptive filter coefficient for the associated node.

Receiving the reference acoustic signal may comprise receiving the reference acoustic signal at a central processing unit, and determining the at least one adaptive filter coefficient for generating an output acoustic signal for at least the first node may comprise receiving, at the central processing unit, the pseudo-error signal associated with the first node and the pseudo-error signal associated with the at least one other node comprised in the plurality of nodes, and determining, at the central processing unit, the at least one adaptive filter coefficient for the first node.

The at least one parameter dependent on the pseudo-error signal may comprise the pseudo-error signal.

The method may comprise providing the at least one adaptive filter coefficient for the first node to the first node.

The plurality of nodes may comprise at least one sub-group comprising a plurality of nodes, the nodes being chosen on the basis of the acoustic coupling level between nodes, wherein the output spectral profile for a first node comprised in a sub-group of nodes is determined in dependence upon the pseudo-error signals associated with at least one other node comprised in the sub-group.

The output acoustic signal for a first node comprised in the sub-group of nodes may be determined in dependence upon the pseudo-error signals associated only with nodes comprised in that sub-group.

For example, considering the entire cabin of an airplane, the nodes in a row of seats generally only need to communicate with the nodes of a limited number of seats located nearby, for example the rows immediately in front and behind, as the nodes of other rows will not have any significant acoustic interaction with the nodes of the row in question.

The target spectral noise profile may be a noise cancellation profile based on an auditory threshold model. The noise cancellation profile may be specified by a user at a node.

The target spectral noise profile may be a noise equalization profile. The noise equalization profile may be specified by a user at a node.

The measured acoustic signal may comprise a desired audio signal and a noise signal, and the target spectral noise profile may be a noise equalization profile determined based on auditory masking of the audio and the noise signals.

The received reference acoustic signal may comprise a periodic noise signal and/or a broadband noise signal.

According to a second aspect, described is a computer program product comprising instructions which, when the program is executed by a computer, cause the computer to carry out the method of the first embodiment.

According to a third aspect, described is an apparatus for active noise equalization comprising a plurality of nodes, each node comprising at least one acoustic sensor and at least one acoustic actuator, and each node having an associated target spectral noise profile and an associated set of adaptive filter coefficients, wherein each node is configured:
to receive a reference acoustic signal;
to generate an output acoustic signal based on the received reference acoustic signal and the associated set of adaptive filter coefficients for the node;
to receive a measured acoustic signal for the node and compute a pseudo-error signal for the node in dependence upon the received measured acoustic signal and the target spectral noise profile associated with the node; and
to update at least one adaptive filter coefficient in the set of adaptive filter coefficients for the node, in dependence upon the pseudo-error signal associated with the node, the reference acoustic signal, and at least one parameter received from at least one other node in the plurality of nodes which is dependent on the pseudo-error signal associated with the at least one other node.

According to a fourth aspect, described is apparatus for active noise equalization comprising:
a plurality of nodes, each node comprising at least one acoustic sensor and at least one acoustic actuator, and each node having an associated target spectral noise profile and an associated set of adaptive filter coefficients; and
a central processing unit in communication with each of the nodes in the plurality of nodes, wherein the central processing unit is configured to receive a reference acoustic signal;
wherein each node is configured:
to generate an output acoustic signal based on the received reference acoustic signal and the associated set of adaptive filter coefficients for the node;
to receive a measured acoustic signal for the node and compute a pseudo-error signal for the node in dependence upon the received measured acoustic signal and the target spectral noise profile associated with the node; and
to provide the pseudo-error signal for the node to the central processing unit;
wherein the central processing unit is configured to update at least one adaptive filter coefficient in the set of adaptive filter coefficients for at least a first node comprised in the plurality of nodes, in dependence upon the pseudo-error signal associated with the first node, the reference acoustic signal, and at least one parameter received from at least one other node in the plurality of nodes which is dependent on the pseudo-error signal associated with the at least one other node.

### BRIEF DESCRIPTION OF THE DRAWINGS

Further features will become apparent from the examples and Figures, wherein:

FIG. 1a is a schematic block diagram of a first active noise equalization system according to embodiments hereof;

FIG. 1b is a schematic block diagram of a second active noise equalization system according to embodiments hereof;

FIG. 2 is a flow chart of a method according to embodiments hereof;

FIG. 3 is a schematic diagram of a first node and a second node comprised in a system according to embodiments hereof, along with acoustic signals and parameters received and generated by the nodes;

FIG. 4 is a schematic representation of signals sent and received in a method according to embodiments hereof implemented with a centralized processing scheme, for periodic noise;

FIG. 5 is a schematic representation of signals sent and received in a method according to embodiments hereof implemented with a distributed processing scheme, for periodic noise;

FIG. 6 is a schematic representation of signals sent and received in a method according to embodiments hereof implemented with a centralized processing scheme, for broadband noise for a first case;

FIG. 7 is a schematic representation of signals sent and received in a method according to embodiments hereof implemented with a centralized processing scheme, for broadband noise for the second case;

FIG. 8 is a schematic representation of signals sent and received in a method according to embodiments hereof implemented with a distributed processing scheme, for broadband noise for a first case;

FIG. 9 is a schematic representation of signals sent and received in a method according to embodiments hereof implemented with a distributed processing scheme, for broadband noise for the second case;

FIG. 10a is a schematic plot of a sound pressure level variation with frequency according to the human hearing threshold model;

FIG. 10b is an example schematic plot of a sound pressure level variation with frequency for a noise equalization profile, with the human hearing threshold model shown in dashed line;

FIG. 11 is a schematic representation of signals sent and received in a method according to embodiments hereof, for active noise equalization when an audio signal is desired to be heard.

### DETAILED DESCRIPTION

The disclosure will be described with respect to particular embodiments and with reference to certain figure drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun, e.g., “a” or “an,” “the,” this includes a plural of that noun unless something else is specifically stated. The term “comprising,” used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein. In the drawings, like reference numerals indicate like features; and, a reference numeral appearing in more than one figure refers to the same element.

Active noise equalization involves modification of an input acoustic signal, also referred to as a reference signal, using adaptive filter coefficients so as to produce an output acoustic signal of a desired form, also referred to as a target spectral noise profile. The choice of the adaptive filter coefficients is determined in part by an error signal and the desired output signal.

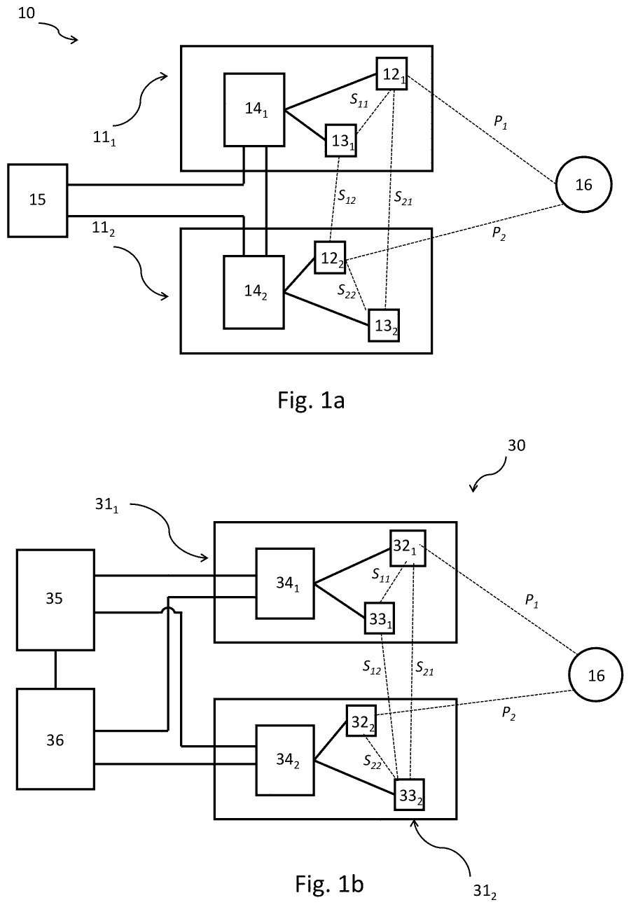

Referring to FIGS. 1a and 1b, active noise equalization systems according to embodiments hereof comprise a plurality of nodes 11, 31. Each node has a different physical location at or near a listening position of a user, for example each node may be installed in or next to a headrest of an associated seat in a vehicle such as a car or airplane or carriage of a train or metro, where at least one node is associated with some or all of the seats. A person sitting in a seat can then hear the output of the loudspeaker comprised in the node associated with the seat. Other examples for the positioning of nodes are different locations in the headboard of a bed, different locations within a home as part of a smart home system, e.g., in a sofa and/or chair. A node associated with a seat or position is configured to perform an active noise equalization according to embodiments hereof for that seat or position. The active noise equalization aims to provide a desired acoustic output in an environment of background noise.

In some situations, it is desired that each passenger can choose a different target spectral noise profile, for example two adjacent passengers may wish to listen to different audio signals; a passenger may wish to block out navigational instructions that are provided to a driver in a different seat; one passenger may desire a noise cancellation profile where another passenger wishes to retain some of the background noise (e.g., for safety reasons). The methods and apparatus according to embodiments hereof allow to achieve such a custom active noise equalization with different outputs at each node.

Each node has an associated set of adaptive filter coefficients which are used to generate the target spectral noise profile for the node by manipulating a reference signal received at the node.

The target spectral noise profile for a node is the acoustic output that is desired to be provided to the user of that node. In some embodiments the target spectral noise profile is a noise cancellation profile. In some embodiments the target spectral noise profile includes a spectral noise profile determined based on acoustic masking properties of an audio signal output by the loudspeaker, such as a piece of music selected by a user, or audio messages produced by a satellite navigation system or safety system.

In some embodiments, the target spectral noise profile is a profile selected by the user which is modified to take into account an auditory threshold spectral profile. The human ear generally responds differently to different sound frequencies, for example is less sensitive to frequencies in the range 20 Hz-1 kHz than to frequencies in the range 1 kHz-4 kHz. For example, if a noise cancellation profile is selected, consider a frequency component having amplitude Ai at frequency f₁ in the spectral profile of noise to be cancelled. At the frequency f₁, if the human ear only responds to signals at this frequency having an amplitude greater than A₂ which is less than A₁, then the target spectral noise profile need only cancel the frequency component at f₁ to the extent that its amplitude is less than or equal to A₂. This allows the efficiency of the system to be improved as unnecessary cancellation of inaudible noise can be avoided.

This can also help to reduce cross coupling between the microphones and loudspeakers of different nodes of spectral components that are substantially inaudible to the human ear.

Each node aims to achieve the target spectral noise profile for the node by generating an appropriate acoustic signal in dependence upon its audio signal environment. For example, if the target spectral noise profile is a noise cancellation profile, the loudspeaker may be configured to produce an anti-noise signal such that the noise components of the background noise and of the loudspeaker cancel each other out at the location of the microphone. Such cancellation may be based on complete cancellation of the background noise such that the amplitude of the audio signal at the microphone is substantially zero at every frequency. Preferably, the noise cancellation profile takes into account a hearing threshold spectrum as described herein before such that the noise is cancelled to the extent that the spectral profile of the audio signal at the microphone conforms to or is less than a hearing threshold spectral profile. This can allow a more efficient noise cancellation to be achieved as there is less cancellation of inaudible components. If the target spectral noise profile is determined based on masking properties of a played audio signal such as a piece of music (optionally selected by a user), or audio messages provided by a satellite navigation system or safety system, the loudspeaker may be configured to produce an equalization signal that reduces the amplitude of the noise to less than or equal to the masking threshold of the played audio signal. In this case, if the masking threshold of the played audio signal at particular frequencies is below a human audibility threshold (for example, if the played audio signal does not contain those frequency components), then the target spectral noise profile can be calculated so as to cancel those frequency components only to the extent defined by the human audibility threshold. The masking threshold of an audio signal indicates the power level below which a noise signal is masked by the audio signal, i.e., the noise becomes inaudible if its power level is below the masking threshold of the audio signal. The masking threshold is generally frequency dependent and can change over time, for example when listening to a piece of music, and so may be continuously updated for a range of frequencies.

In some embodiments, the target spectral noise profile can be calculated so as to reduce, or preferably eliminate, or reduce to less than or equal to the amplitude of such a frequency component in a human auditory threshold model, frequency components in the background noise, for example by producing an anti-noise signal at those frequencies while the music signal is played and/or to modify frequency components of the background noise, for example by increasing or decreasing their amplitude.

### First Active Noise Equalization System

Referring to FIG. 1a, a first active noise equalization system 10 according to embodiments hereof is shown.

The first active noise equalization system 10 comprises a plurality of nodes 11. Although two nodes are shown in FIG. 1a, a first active noise equalization system according to embodiments hereof may comprise three, four, or more nodes. Each node 11 comprises an acoustic receiver 12, such as a microphone, and an acoustic actuator 13, such as a loudspeaker. Each node 11 also comprises a processing unit 14 configured to receive data, for example from the acoustic receiver 12 of the node, and from other nodes 11. The processing unit 14 is also configured to send data, for example to send output signals to the acoustic actuator 13 of the node, and to send at least one parameter dependent on the pseudo-error signal associated with the node to at least one of the other nodes 11. The processing unit 11 is also configured to update active filter coefficients associated with the node for generating an output acoustic signal for the node. The processing unit 14 comprises a memory (not shown) which stores a target spectral noise profile for the corresponding node 11. Each node 11 is connected to at least one other node in the plurality of nodes 11 by a wired or wireless connection.

The first active noise equalization system can also be thought of as a distributed system as no central processing unit is necessary and the nodes exchange parameters with each other. All calculations for updating the adaptive filter coefficients are done at the nodes.

Exchange of signals will now be described with respect to a first node 11₁ and a second node 11₂ comprised in the plurality of nodes 11, although it will be understood that the described signal paths also exist with respect to any other nodes comprised in the plurality of nodes. The present invention is not limited to methods and apparatus concerning only two nodes. Three or four or more nodes may be used.

### Audio Signals

The microphone 12₁ of the first node 11₁ is configured to receive an audio signal including a signal along acoustic path S₁₁ from the loudspeaker 13₁ of the first node 11₁, a signal along acoustic path S₂₁ from the loudspeaker 13₂ of the second node 11₂, and a background noise signal along acoustic path P₁ from a background noise source 16. The first node 11₁ has a target spectral noise profile M₁.

The microphone 12₂ of the second node 11₂ is configured to receive an audio signal including a signal along acoustic path S₁₂ from the loudspeaker 13₁ of the first node 11₁, a signal along acoustic path S22 from the loudspeaker 13₂ of the second node 11₂, and a background noise signal along acoustic path P₂ from the background noise source 16. The second node 11₂ has a target spectral noise profile M₂.

The reference signal generator 15 is configured to provide a reference signal to the first node 11₁ and the second node 11₂. In some embodiments the reference signal generator 15 is configured to receive a background noise signal from the background noise source 16. For example, the reference signal generator 15 may receive a background noise signal that propagates along an acoustic path from the background noise source 16 to the reference signal generator 15.

### Signal Processing

The processor 14₁ of the first node 11₁ is configured to determine the pseudo-error signal of the first node 11₁ based on the error signal of the first node 11₁, that is, the signal measured by the microphone 13₁ of the first node 11₁, and the target spectral noise profile of the first node 11₁, as will be described in further detail hereinafter.

The processor 14₂ of the second node 11₂ is configured to combine the error signal of the second node 11₂, that is, the signal measured by the microphone 12₂ of the second node 11₂, with the target spectral noise profile of the second node 11₂ to form the pseudo-error signal of the second node 11₂, as will be described in further detail hereinafter.

Each processor 14₁, 14₂ is configured to receive a reference signal from the reference signal generator 15 and calculates an initial set of adaptive filter parameters for the associated node, as will be described in more detail hereinafter.

By exchanging adaptive filter parameters between nodes, instead of exchanging the full pseudo-error signal, the parameter exchange is more efficient as it can occur at a lower rate and consume less energy and bandwidth.

Each processor 14₁, 14₂ is optionally also configured to determine the secondary acoustic paths of the respective node, as will be described in more detail hereinafter.

### Second Active Noise Equalization System

Referring to FIG. 1b, a second active noise equalization system 30 according to embodiments hereof is shown. The second active noise equalization system 30 comprises a plurality of nodes 31. Although two nodes are shown in FIG. 1b, a second active noise equalization system according to embodiments hereof may comprise three, four, or more nodes. Each node 31 comprises an acoustic receiver 32, such as a microphone, and an acoustic actuator 33, such as a loudspeaker. Each node 31 also comprises a processing unit 34 configured to receive data, for example from the acoustic receiver 32 of the node. The processing unit 34 comprises a memory (not shown) which stores a target spectral noise profile for the corresponding node 31. The processing unit 34 is configured to, for each node 31, 1) calculate a pseudo-error signal for node, 2) filter the received reference signal with the adaptive filter coefficients, and 3) provide the output signal to be generated by the loudspeaker of the node to the node.

The second active noise equalization system 30 comprises a central processing unit 35 which is connected to each of the nodes in the plurality of nodes 31 by wired or wireless connections. The central processing unit 35 is configured to receive data from the plurality of nodes 31, to process received data, and to provide data to the plurality of nodes 31. In particular, the central processing unit 35 is configured to update active filter coefficients associated with at least one node in the plurality of nodes 31. The central processing unit 35 is configured to receive target spectral noise profiles from each node, a reference signal from the reference signal generator 36, and pseudo-errors from each node. The central processing unit 35 is optionally configured to determine secondary acoustic paths for each node 31, as will be described in more detail hereinafter.

The second ANE system can also be thought of as a centralized system as the pseudo-error signals for the nodes are sent to a central processing unit which is configured to determine the adaptive filter parameters for the nodes simultaneously.

Exchange of signals will now be described with respect to a first node 31₁ and a second node 31₂ comprised in the plurality of nodes 31, although it will be understood that the described signal paths also exist with respect to any other nodes comprised in the plurality of nodes.

### Audio Signals

The microphone 32₁ of the first node 31₁ is configured to receive an audio signal including a signal along acoustic path S₁₁ from the loudspeaker 33₁ of the first node 31₁, a signal along acoustic path S₂₁ from the loudspeaker 33₂ of the second node 31₂, and a background noise signal along acoustic path P₁ from a background noise source 16. The first node 31₁ has a target spectral noise profile M₁.

The microphone 32₂ of the second node 31₂ is configured to receive an audio signal including a signal along acoustic path S₁₂ from the loudspeaker 33₁ of the first node 31₁, a signal along acoustic path S₂₂ from the loudspeaker 33₂ of the second node 31₂, and a background noise signal along acoustic path P₂ from the background noise source 16. The second node 31₂ has a target spectral noise profile M₂.

The reference signal generator 36 is configured to provide a reference signal to the central processing unit 35 and to each of the nodes 31. In some embodiments, the reference signal generator 36 is configured to receive a background noise signal from the background noise source 16. For example, the reference signal generator 36 may receive a background noise signal that propagates along an acoustic path from the background noise source 16 to the reference signal generator 36.

### Signal Processing

The first node 31₁ is configured to determine the pseudo-error signal of the first node 31₁ based on the error signal of the first node 31₁, that is, the signal measured by the microphone 32₁ of the first node 31₁, and the target spectral noise profile M₁ of the first node 31₁, as will be described in more detail hereinafter. This operation takes place at the first node 31₁.

The second node 31₂ is configured to determine the pseudo-error signal of the second node 31₂ based on the error signal of the second node 31₂, that is, the signal measured by the microphone 32₂ of the second node 31₂, and the target spectral noise profile M₂ of the second node 31₂, as will be described in more detail hereinafter. This operation takes place at the second node 31_{2.}

The central processing unit 35 is configured to receive a reference signal from the reference signal generator 36 and also to receive the pseudo-error signals from the first node 31₁ and the second node 31₂. The central processing unit is configured to update adaptive filter parameters for the first node 31₁ in dependence upon the pseudo-error signal for the first node 31₁, the pseudo-error signal of the second node 31₂, and the reference signal, as will be described in more detail hereinafter.

The central processing unit 35 is configured to provide the calculated adaptive filter parameters to the respective nodes.

The central processing unit 35 may communicate with the nodes 31₁, 31₂ and the reference signal generator 36 using any suitable wired or wireless connection, such as Ethernet, Bluetooth, Bluetooth Low Energy (BLE) Wi-Fi, near-field communication (NFC), cellular network, low power wireless personal area network.

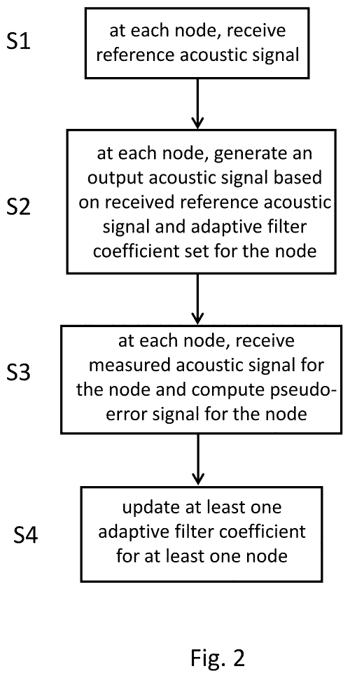

The first and second active noise equalization systems 10, 30 are each configured to carry out a method according to embodiments hereof. Referring to FIG. 2, the method according to embodiments hereof comprises the steps of:

### Step S1

A reference acoustic signal is received. The reference acoustic signal is related to a background noise signal, such as that from an engine, generated by a noise source, which is desired to be equalized or cancelled. In some embodiments, the reference acoustic signal is measured by a microphone placed near to the noise source. In some embodiments, the reference acoustic signal is generated by the active noise equalization system as a signal that is representative of the background noise. The signal may be a periodic or single frequency signal. The signal may be a broadband signal.

A reference signal associated with background noise that is periodic is preferably generated by an internal signal generator comprised in the active noise equalization apparatus. A reference signal associated with background noise that is broadband is preferably generated by receiving the background noise signal using a microphone or other acoustic receiver located close to the noise source. The signal may include a first, periodic component and a second, broadband component and the first and second components may be generated using different means.

The same reference signal is received for each node. That is, in embodiments wherein the reference signal is received at each node, the same reference signal is received at each node; in embodiments wherein the reference signal is received at a central processing unit, the same reference signal is used for each node. The sets of adaptive filter coefficients, which are individually configurable for each node, allow to account for differences in the actual background noise signal at each node, for example due to differing acoustic paths between the background noise source and each node. For example, an acoustic path between an engine and a front seat of a car is different to an acoustic path between an engine and a rear seat in a car.

For example, in the first active noise equalization system 10, the reference signal is received by each node 11. The first active noise equalization system 10 may comprise a reference signal module 15 for providing the reference signal to each node 11. The reference signal module 15 may itself receive the reference signal from an external source, such as a microphone placed near to the noise source, or may alternatively generate the reference signal internally. The reference signal module 15 may synthesize the reference signal based on a synchronization signal received from the noise source, for example from a tachometer sensor for measuring the rotation speed of an engine.

In the second active noise equalization system 30, the reference signal is received by the central processing unit 35. The second active noise equalization system 30 may comprise a reference signal module 36 for providing the reference signal to the central processing unit 35. The reference signal module 36 may itself receive the reference signal from an external source, such as a microphone placed near to the noise source, or may alternatively generate the reference signal internally. The reference signal module 36 may synthesize the reference signal based on a synchronization signal received from the noise source, for example from a tachometer sensor for measuring the rotation speed of an engine. The reference signal module 36 may be comprised in the central processing unit 35 or may be separate from the central processing unit 35.

In both the first and the second active noise equalization systems 10, 30, a first and a second reference signal module may be provided. For example, a first reference signal module may be provided for synthesizing a reference signal corresponding to periodic noise and a second reference signal module may be provided for providing a reference signal directly measured close to the noise source.

### Step S2

At each node, an output acoustic signal is generated based on the received reference acoustic signal and the associated set of adaptive filter coefficients for the node.

The method according to embodiments hereof may comprise an initialization step, in which the set of adaptive filter coefficients for each node are initialized, before a first execution of steps S1-S4. The adaptive filter coefficients may be initialized for example by setting each coefficient to zero or to a randomly generated value. In the equations presented hereinafter, the initialization occurs at time step n=0.

The associated set of adaptive filter coefficients used in step S2 are thus either the set of adaptive filter coefficients as initialized in an initialization step, or the set of adaptive filter coefficients obtained in step S4 of the preceding implementation of steps S1-S4 of the method.

### Step S3

At each node, a measured acoustic signal for the node is received. For example, in each node 11, 31, the acoustic signal may be measured by the acoustic receiver 12, 32, and provided to the processing unit 14, 34. The acoustic signal measured for a particular node is generally different to the acoustic signals measured for other nodes in the plurality of nodes, as each node may receive, in addition to a background noise signal such as that from an engine, an acoustic signal from an actuator 13 comprised in a different node as generated in step S2. That is, the measured acoustic signal may include multiple noise signals which vary between nodes. The measurement of step S3 and the acoustic signal generation of step S2 may take place substantially simultaneously.

At each node, a pseudo-error signal for the node is computed in dependence upon the received measured acoustic signal for the node and the target spectral noise profile associated with the node.

For example, the processing unit 14, 34 of each node 11 receives the acoustic signal and computes a pseudo-error signal for the node in dependence upon the received acoustic signal and the target spectral noise profile associated with the node, which may be for example stored in a memory (not shown) of the processing unit 14, 34.

The method of calculating the pseudo-error signal may vary depending on the particular configuration of the active noise equalization system and the type or types of noise present in the reference acoustic signal.

### Step S4

In step S4, at least one adaptive filter coefficient for generating an output acoustic signal for at least one node is determined. The at least one adaptive filter coefficient is determined in dependence on the pseudo-error signal associated with the node, the reference acoustic signal, and at least one parameter received from at least one other node in the plurality of nodes. The at least one adaptive filter coefficient may optionally be determined in dependence upon the secondary paths of the node. The at least one parameter is dependent on the pseudo-error signal associated with the at least one other node.

For example, in the first active noise equalization system 10, the at least one node stores its pseudo-error signal (as calculated in step S3) and the reference acoustic signal (as received in step S), and in step S4 receives at least one parameter from at least one other node in the plurality of nodes. The at least one parameter is preferably at least one adaptive filter coefficient for generating an output acoustic signal for the other node, this adaptive filter coefficient being generated in dependence on the pseudo-error signal associated with the other node.

The at least one node then determines at least one adaptive filter coefficient for the at least one node in dependence on the pseudo-error signal of the at least one node, the reference signal, and the at least one adaptive filter coefficient of the at least one other node.

The nodes 11 in the first active noise equalization system 10 may exchange parameters in a sequential manner, for example in embodiments wherein the plurality of nodes 11 consists of first, second, third, and fourth nodes, the first node may provide its locally updated adaptive filter coefficients to the second node, the second node may provide its locally updated adaptive filter coefficients to the third node, the third node may provide its locally updated adaptive filter coefficients to the fourth node, and the fourth node may provide its locally updated adaptive filter coefficients to the first, second, and third nodes. The locally updated adaptive filter coefficients are adaptive filter coefficients updated based on the pseudo-error signal of one node only. The locally updated adaptive filter coefficients of the fourth node are then global adaptive filter coefficients for all the nodes, that is, the fourth node has a set of adaptive filter coefficients updated based on the pseudo-error signals of all nodes. This set of adaptive filter coefficients is equivalent to the set of adaptive filter coefficients that the fourth node would receive from the central processing unit in the centralized case. The fourth node optionally then communicates this global set of adaptive filter coefficients to the first node, and the first to the second, and so on. The first node may initially determine an initial set of adaptive filter coefficients in dependence upon its pseudo-error signal and the reference signal, that is, without receiving parameters from another node. The initial set of adaptive filter coefficients can also be referred to as the local set of adaptive filter coefficients. This initial set of adaptive filter coefficients can then be provided to the second node, which uses the adaptive filter coefficients of the first node to calculate its own adaptive filter coefficients. By locally updated adaptive filter coefficients it is meant adaptive filter coefficients updated based only on the pseudo-error signal of the node in question and the reference signal.

The nodes 11 in the first active noise equalization system 10 may exchange parameters in a diffusion-type manner, wherein each node sends its at least one parameter to every other node in the plurality of nodes and receives at least one parameter from every other node in the plurality of nodes.

In the second active noise equalization system 30, the central processing unit 35 receives the pseudo-error signal of at least one node (as calculated in step S3) and the reference acoustic signal (as received in step S1), and in step S4 receives at least one parameter dependent on the pseudo-error signal associated with at least one other node from the at least one other node. The at least one parameter dependent on the pseudo-error signal is the pseudo-error signal of the at least one other node. The central processing unit 35 then determines at least one adaptive filter coefficient for the at least one node in dependence on the pseudo-error signal of the at least one node, the reference signal, and the pseudo-error signal of the at least one other node.

By calculating individual pseudo-error signals for each node and determining adaptive filter coefficients based on pseudo-error signals of other nodes, or parameters derived therefrom, the method according to embodiments hereof allows improved active noise equalization to be carried out with an individual target output profile for each node.

An output acoustic signal for each node can then be calculated as the action of the set of adaptive filter coefficients for each node on the reference signal, as will be described in more detail hereinafter. The output acoustic signal for each node can be output by the loudspeaker comprised in the respective node.

### Secondary Acoustic Paths

A set of secondary acoustic paths exists for each pairing of a loudspeaker and an actuator. For example, referring to FIG. 1a, for the first node 11₁ there is a secondary acoustic path S₁₁ between the loudspeaker 13₁ of the first node 11₁ and the receiver 12₁ of the first node 11₁, and a secondary acoustic path S₂₁ between the loudspeaker 13₂ of the second node 11₂ and the receiver 12₁ of the first node 11₁. Each secondary path can be described by a finite impulse response (FIR) filter, which characterizes the acoustic impulse response (AIR) between an acoustic actuator and an acoustic receiver.

In the first active noise equalization system 10, the secondary paths can be determined at the processors 14 of each node. This step can take place once when the system is installed in a particular environment, such as a car or train carriage. The secondary path determination may be repeated at set intervals.

In the second active noise equalization system 30, the secondary paths can be determined at the processors 34 of each node and provided to the central processing unit 35.

To determine the secondary paths, a single actuator 13ᵢ outputs a specifically designed signal of finite duration, for example a maximum length sequence. The receiver 12ⱼ of each node 11ⱼ records the signal received at that node. The processing unit 14ⱼ of each node then estimates the AIR, thus obtaining the coefficients of an FIR filter that models the secondary path between the receiver 12ⱼ and the actuator 13ᵢ. The specific determination of the FIR coefficients depends on the type of signal used. Example methods are described in A. Farina, “Simultaneous Measurement of Impulse Response and Distortion with a Swept-Sine Technique,” Audio Engineering Society Convention 108, 2000, vol. 5093, pp. 1-15, and in M. Vorländer and M. Kob, “Practical aspects of MLS measurements in building acoustics,” Appl. Acoust., vol. 52, no. 3-4, pp. 239-258, November 1997. However, other suitable methods may be used.

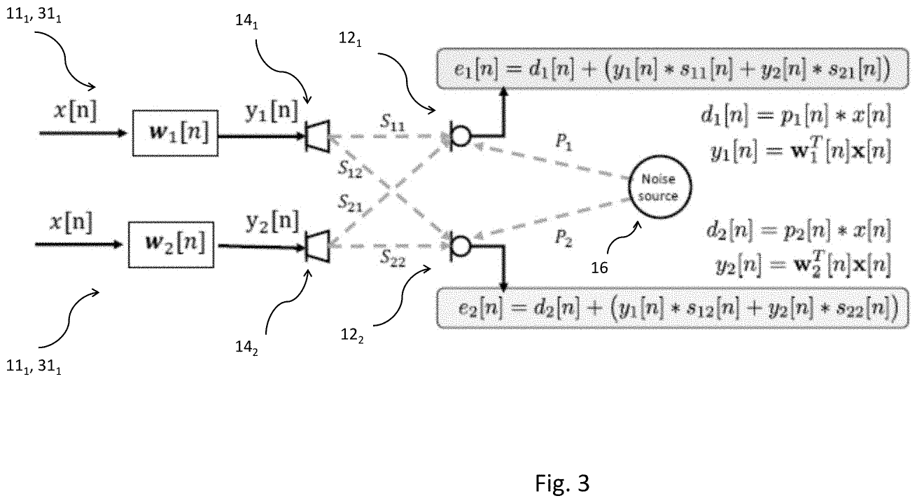

Referring to FIG. 3, a schematic diagram of a first node 11₁, 31₁ and a second node 11₂, 31₂ comprised in a system 10, 30 according to embodiments hereof is shown, along with the acoustic signals and parameters received and generated. Although the nodes each comprise one acoustic receiver 12₁, 12₂ respectively and one acoustic actuator 13₁, 13₂ respectively, the present invention is not limited thereto and each node may comprise additional acoustic receivers and actuators.

In the following, each node is labelled using a unique index k which runs from 1 to K, i.e., there are K nodes comprised in the system.

The measured acoustic signal eₖ[n] for each node, which may also be referred to as an error signal, can be expressed according to equation 1:

$${e}_{k} [ n ] = {d}_{k} [ n ] + {\sum }_{j = 1}^{K} ( {y}_{j} [ n ] * {s}_{jk} [ n ] ) \qquad ( 1 )$$

where:

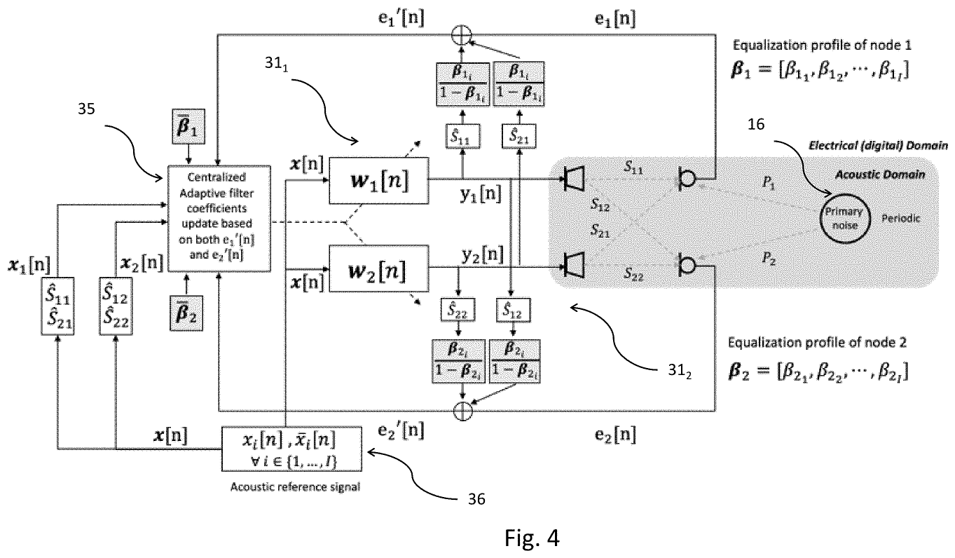

dₖ[n] is the component of the error signal eₖ[n] received from the noise source 16. d[n] represents the noise source signal at the noise source filtered through an acoustic path pₖ[n] which links the noise source and the node. For example, this path for the first node 11₁ is labelled as P₁ in FIG. 4.

yⱼ[n]=wⱼ[n]^{T}x[n] is the output acoustic signal of node j, where wₖ denotes the set of l_{w} adaptive filter coefficients of node k, and x[n] denotes the (proper number of) preceding samples of the received reference signal before the time instance n. The sampling rate may be determined by the type of hardware used for implementing the method.

sⱼₖ [n] denotes the acoustic path between the acoustic actuator of node j and the acoustic receiver of node k, also referred to as the secondary acoustic path between node j and node k, and is mathematically modelled by a Finite Impulse Response (FIR) filter of length lₛ. For example, the secondary acoustic path between the acoustic actuator 14₂ of the second node 11₂ and the acoustic receiver 12₁ of the first node 11₁ is labelled as S₂₁ in FIG. 4. When transformed to the z-domain, a secondary acoustic path scales each frequency by a frequency-specific amount. The index n in sⱼₖ[n] is kept as matching the time instant of the signal, yⱼ[n], of the convolution operation. However, the acoustic path does not change with time provided that the relative positions of the nodes do not change. Thus after their estimation as described herein, the acoustic paths sⱼₖ[n] remain unchanged unless they need to be recalculated due to changes in the system or any other circumstance/requirement.

The symbol * denotes a linear convolution operation.

The error signal eₖ[n] of equation 1 can be represented in the z-transform domain according to equation 2:

$${E}_{k} ( z ) = {D}_{k} ( z ) + {\sum }_{j = 1}^{K} {Y}_{j} ( z ) {S}_{jk} ( z ) \qquad ( 2 )$$

where Eₖ(z), Dₖ(z), Yⱼ(z), and Sⱼₖ(z) are the z-transformations of eₖ[n], dₖ[n], y[n] and sⱼₖ[n] respectively. The z-transform Yⱼ(z) can be written as Yⱼ(z)=Wⱼ(z) X(z), where Wⱼ(z) is the z-transform of wⱼ[n] and X(z) is the z-transform of x[n].

Methods according to embodiments hereof allow adaptive filter coefficients wₖ[n] to be determined which can be used to generate output acoustic signals yₖ[n] such that the target output spectral noise profile is achieved.

As seen from equation 1, the error signal has two components: dₖ[n], which is the noise component measured by the acoustic sensor of node k which originates from the noise source, and the summation term, which is the sum of the output acoustic signals originating from the acoustic actuators of all nodes.

Methods of determining adaptive filter coefficients in various situations and configurations will now be described with reference to FIGS. 4 to 9.

### Periodic Noise

In the case of periodic noise, the background noise signal can be represented as I different periodic components, each having a frequency ωᵢ, where i runs from 1 to I. The noise equalization profile, or target spectral noise profile, for a node k can be written according to equation 3:

βₖ=[β_{K}_{₁}, βₖ_{₂}, . . . βₖ_{_{I}}] (3)

where βₖ₁ is the equalization factor applied by node k to the frequency component having frequency ωᵢ. This equalization vector βₖ is in general different at each node.

The per-node equalization vector of equation 3 allows the objective to be achieved at each node k at frequency ωᵢ (that is, when z=e^{jω}^{ᵢ}, where j is the imaginary unit) to be written according to equation 4:

$${E}_{k} ( {e}^{j {ω}_{i}} ) = {β}_{{k}_{i}} {D}_{k} ( {e}^{j {ω}_{i}} ) , ∀ {ω}_{i} , i = 1 , 2 , … , I \qquad ( 4 )$$

The objective is that the z-transform of the error signal eₖ[n] at each node k is a scaled version of the z-transform of the error signal received from the noise source dₖ[n], where the scaling for each frequency is defined by the noise equalization profile.

For periodic noise, the reference signal comprises in-phase components xᵢ[n] and quadrature components x̅ᵢ[n] defined for each frequency a according to equations 5 and 6:

$$\begin{matrix}{x}_{i} [ n ] = {A}_{i} cos ( {ω}_{1} n ) & ( 5 ) \\ {\overline{x}}_{i} [ n ] = {A}_{i} sin ( {ω}_{1} n ) & ( 6 )\end{matrix}$$

where Aᵢ is the amplitude of the i-th frequency in the reference signal. Defining the reference signal as xᵢ[n]=[xᵢ[n]x̅ᵢ[n]]^{T}, the output acoustic signal at node k for frequency ωᵢ can be written according to equation 7:

$${y}_{{k}_{i}} [ n ] = {w}_{{k}_{i}}^{T} [ n ] {x}_{i} [ n ] \qquad ( 7 )$$

where wₖ_{ᵢ}[n] is a 2-tap adaptive filter containing the adaptive filter coefficients of node k for frequency ωᵢ . The output acoustic signal to be generated at node k is then obtained by the summation yₖ[n]=Σᵢ₌₁^{l}yₖ_{ᵢ}[n].

### Updating the Adaptive Filter Coefficients

The wₖ_{ᵢ}[n] need to be determined at each node k so as to achieve the target spectral noise profile for each node. A pseudo-error signal at node k can be defined according to equation 8:

$${e}_{k}^{′} [ n ] = {e}_{k} [ n ] + {\sum }_{i = 1}^{I} \frac{{β}_{{k}_{i}}}{1 - {β}_{{k}_{i}}} {\sum }_{j = 1}^{K} {y}_{{j}_{i}} [ n ] * {\hat{s}}_{jk} [ n ] \qquad ( 8 )$$

The hat notation denotes an estimated parameter. The pseudo-error signal can be represented in the z-transform domain according to equation 9:

$${E}_{k}^{′} ( z ) = {E}_{k} ( z ) + {\sum }_{i = 1}^{I} \frac{{β}_{{k}_{i}}}{1 - {β}_{{k}_{i}}} {\sum }_{j = 1}^{K} {Y}_{{j}_{i}} ( z ) {\hat{S}}_{jk} ( z ) \qquad ( 9 )$$

By minimizing the z-transformed pseudo-error signal E′ₖ(z), it can be proved that equation 4 is simultaneously satisfied at each node.

The k-th filter updating equation for the i-th acoustic reference signal, also written as wᵢ_{ₖ}, can then be calculated, for example based on the FxLMS methods described in D. R. Morgan, An analysis of multiple correlation cancellation loops with a filter in the auxiliary path, EEE Trans. Acoust., Speech, Signal Processing, vol. ASSP-28, pp. 454467, August 1980 or S. Elliott, I. Stothers, and P. Nelson, “A multiple error LMS algorithm and its application to the active control of sound and vibration,” IEEE Transactions on Acoustics, Speech, and Signal Processing, vol. 35, no. 10, pp. 1423-1434, October 1987, and is calculated according to equation 10:

$${w}_{{k}_{i}} [ n + 1 ] = {w}_{{k}_{i}} [ n ] - 2 {μ}_{i} {\sum }_{j = 1}^{K} {x}_{{kj}_{i}} [ n ] \frac{1}{1 - {β}_{{k}_{i}}} {e}_{j}^{′} [ n ] \qquad ( 10 )$$

where xₖⱼ_{ᵢ}[n] is a vector containing the in-phase and quadrature components of the reference signal at frequency i, i.e., xᵢ[n] and x̅ᵢ[n] respectively, when filtered by the corresponding secondary path ŝₖⱼ[n], that is, according to equations 11:

$${x}_{{kj}_{i}} [ n ] {=}^{Δ} [ \begin{matrix}{x}_{{kj}_{i}} [ n ] \\ {\overline{x}}_{{kj}_{i}} [ n ]\end{matrix} ] = [ \begin{matrix}{x}_{i} [ n ] * {\hat{s}}_{jk} [ n ] \\ {\overline{x}}_{i} [ n ] * {\hat{s}}_{jk} [ n ]\end{matrix} ] \qquad ( 11 )$$

Since the in-phase and quadrature components are tones, the values of Xₖⱼ_{ᵢ}[n] and x̅ₖⱼ_{ᵢ}[n] can easily be calculated through the frequency response Ŝₖⱼ(e^{jω}^{ᵢ}) of the corresponding secondary path at frequency f according to equations 12:

$$[ \begin{matrix}{x}_{{kj}_{i}} [ n ] \\ {\overline{x}}_{{kj}_{i}} [ n ]\end{matrix} ] = [ \begin{matrix}\vert {\hat{S}}_{kj} ( {e}^{j {ω}_{i}} ) \vert {A}_{i} cos ( 2 π {f}_{i} n + ∠ {\hat{S}}_{kj} ( {e}^{j {ω}_{i}} ) ) \\ \vert {\hat{S}}_{kj} ( {e}^{j {ω}_{i}} ) \vert {A}_{i} sin ( 2 π {f}_{i} n + ∠ {\hat{S}}_{kj} ( {e}^{j {ω}_{i}} ) )\end{matrix} ] \qquad ( 12 )$$

The scaling term (1−βₖ_{ᵢ})⁻¹ in equation 10 ensures that the node generates its output acoustic profile in accordance with its associated target spectral noise profile. In equation 10, μ is the step size for the i-th acoustic reference signal. The step size defines the jumps of the FxLMS algorithm in between iterations and is chosen such that convergence of the FxLMS as an adaptive filter is achieved.

In this manner, each node does not need to know the target spectral noise profile of the other nodes, which reduces the amount of data which is required to be shared between nodes, making the equalization process more efficient.

### Updating in a Centralized Processing Scheme

Let w[n] denote a global 2IK-tap adaptive filter obtained by stacking all wₖ_{ᵢ}, first for all the frequencies labelled by i and then for all the nodes labelled by k. w[n] can then be updated according to equation 13:

$$w [ n + 1 ] = w [ n ] - 2 μ {\sum }_{j = 1}^{K} \overline{β} {x}_{j} [ n ] {e}_{j}^{′} [ n ] \qquad ( 13 )$$

where μ is a diagonal matrix of dimension 2IK×2IK, defined as μ=diag(μ₁, . . . , μ_{K}), in which μₖ is a diagonal matrix of dimension 2I arranged such that μₖ=diag(μₖ_{₁}, μₖ_{₁} . . . , μₖ_{₁}, μₖ_{₁}), and where β̅ is a diagonal matrix of dimension 2IK×2IK whose diagonal elements are the values of (1−βₖ_{ᵢ})⁻¹, for all nodes k and all frequencies i, i.e., β̅=diag(β̅₁, . . . , β̅_{K}), where β̅ₖ is a diagonal matrix of dimension 2I arranged such that

$${\overline{β}}_{k} = [ \frac{1}{1 - {β}_{{k}_{1}}} , \frac{1}{1 - {β}_{{k}_{1}}} , … , \frac{1}{1 - {β}_{{k}_{I}}} , \frac{1}{1 - {β}_{{k}_{I}}} ] .$$

Note that in these cases, the repetition of μₖ_{ᵢ} and

$$\frac{1}{1 - {β}_{{k}_{1}}}$$

values for two times in μₖ and β̅ₖ, respectively, is to properly scale the in-phase and quadrature components xₖⱼ_{ᵢ}[n] and x̅ₖⱼ_{ᵢ}[n].

The vector xⱼ[n] of dimension 2IK is obtained by stacking xₖⱼ[n] from k=1 to k=K according to the ordering of w[n], i.e., according to equation 14:

$${x}_{kj} [ n ] = {[ {x}_{{kj}_{1}}^{T} [ n ] , {x}_{{kj}_{2}}^{T} [ n ] , … , {x}_{{kj}_{I}}^{T} [ n ] ]}^{T} \qquad ( 14 )$$

and i=1, 2, . . . , I.

The signals sent and received in this scheme are shown in FIG. 4.

### Updating in a Distributed Processing Scheme

To calculate the distributed version of the adaptive filter of equation 10, the sum of 10 can be split such that each node j can update the j-th term of the sum by relying only on its own pseudo-error signal e′ⱼ[n].

Define w^{j}[n] as the local version of the global filter w[n] at time instance n, updated at the j-th node. Then the adaptive filter coefficients can be updated according to equation 15:

$${w}^{j} [ n ] = {w}^{j - 1} [ n ] - μ \overline{β} {x}_{j} [ n ] {e}_{j}^{′} [ n ] \qquad ( 15 )$$

where w⁰[n]=w^{K}[n−1]=w[n−1], and where β̅=diag(β̅₁, . . . , β̅_{K}), with

$${\overline{β}}_{k} = [ \frac{1}{1 - {β}_{{k}_{1}}} , \frac{1}{1 - {β}_{{k}_{2}}} , … , \frac{1}{1 - {β}_{{k}_{I}}} ] .$$

In a diffusion algorithm, the structure of the network is such that each node shares its state information through neighbor nodes. Considering that each k-th node can share information with a group of Nₖ nodes to which it is connected, the adaptation equation 15 can then be expressed according to equation 16:

$${w}^{j} [ n ] = {Σ}_{i ∈ {N}_{k}} {α}_{ik} {w}^{i} [ n - 1 ] - 2 μ \overline{β} {x}_{j} [ n ] {e}_{j}^{′} [ n ] \qquad ( 16 )$$

where αᵢₖ>0 are the parameters that control the collaboration within the network, and Σ_{i∈N}_{ₖ}αᵢₖ=1. An example of a diffusion network, which may be used in embodiments hereof, is described in A. Gonzalez, M. Ferrer, M. De Diego, and G. Pinero, “Algoritmo de Difusion para Control Activo de Ruido en Redes Distribuidas,” in XXIX Simposium Nacional de la Union Cientifica Internacional de Radio, URSI, 2014, pp. 1-4.

An example of an incremental network that is used to transmit w^{j-1}[n] from node (j−1) to node j, and a method of transmitting the final global vector to each node after the updating stage, is described in “Incremental multiple error filtered-X LMS for node-specific active noise control over wireless acoustic sensor networks,” Plata-Chaves et al., 2016 IEEE Sensor Array and Multichannel Signal Processing Workshop (SAM), 2016. In the method described therein, to obtain the local pseudo-error signal e′ⱼ[n], every generated output acoustic signal yₖ[n] is first calculated at node j according to equation 17:

$${y}_{k} [ n ] = {( {w}_{k}^{0} [ n ] )}^{T} x [ n ] \\ where \\ {w}_{k}^{0} [ n ] = {[ {w}^{0} [ n ] ]}_{( 2 I ( k - 1 ) + 1 \text{:} 2 Ik )} \qquad ( 17 )$$

is a vector of dimensions 2l×1 whose elements are the filter coefficients of node k of the most recent updated global vector wₖ⁰[n]. The vector x[n] is then composed of the ordered sampled of the in-phase and quadrature reference signals for all frequencies, as in equation 18:

$$x [ n ] = {[ {x}_{1} [ n ] , {\overline{x}}_{1} [ n ] , {x}_{2} [ n ] , {\overline{x}}_{2} [ n ] , … , {x}_{I} [ n ] , {\overline{x}}_{I} [ n ] , ]}^{T} \qquad ( 18 )$$

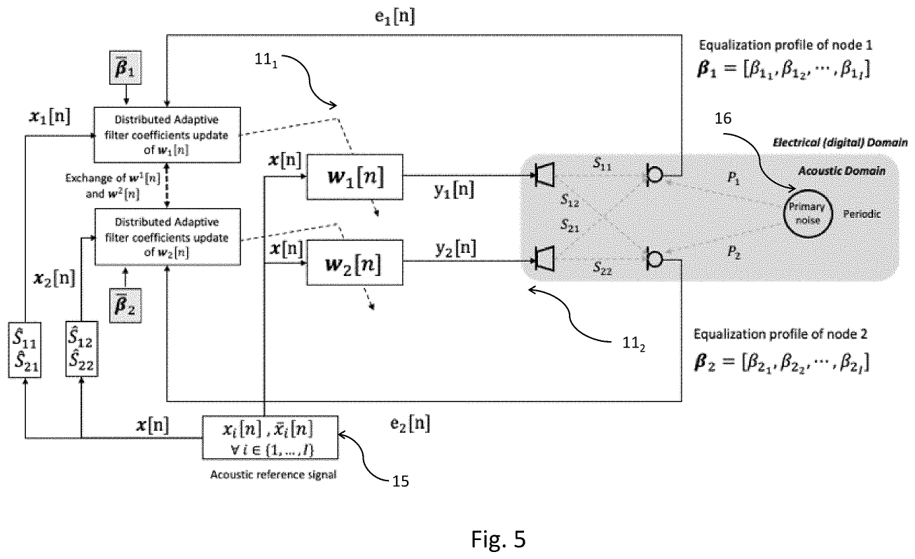

The signals sent and received in this scheme are shown in FIG. 5.

### Broadband Noise

When the background noise signal is broadband, the acoustic signal to be output at node k can be written according to equation 19:

$${y}_{k} [ n ] = {w}_{k}^{T} [ n ] x [ n ] \qquad ( 19 )$$

where wₖ[n] is the vector containing l_{w} adaptive filter coefficients, and where x[n] is as defined hereinbefore.

Embodiments hereof provide strategies for the treatment of such broadband noise, two of which are described hereinafter.

### Case 1

The equalization profile of each node k, also known as its target spectral noise profile, is defined based on a noise shaping filter Cₖ(z), being the z-transform of the target spectral noise profile. Then the objective of each node can be expressed according to equation 20:

$${E}_{k} ( z ) = {C}_{k} ( z ) {D}_{k} ( z ) \qquad ( 20 )$$

In order to achieve such an error signal at each node, the pseudo-error signal can be calculated according to equation 21:

$${E}_{k}^{′} ( z ) = {E}_{k} ( z ) + \frac{{C}_{k} ( z )}{1 - {C}_{k} ( z )} {\sum }_{j = 1}^{K} {Y}_{j} ( z ) {\hat{S}}_{jk} ( z ) \qquad ( 21 )$$

As E′ₖ(z) approaches zero, at each node Eₖ(z) approaches Cₖ(z)Dₖ(z).

The coefficients of the adaptive filter of node k denoted by wₖ[n] are updated to simultaneously minimize all of the pseudo-error signals. This is done by updating according to equation 22:

$${w}_{k} [ n ] = {w}_{k} [ n - 1 ] - 2 μ {\sum }_{j = 1}^{K} {ϰ}_{kj} [ n ] {e}_{j}^{′} [ n ] \qquad ( 22 )$$

where xₖⱼ[n] is the vector containing the last l_{w} instances of xₖⱼ[n]=x[n]*hₖⱼ[n], where hₖⱼ[n] is an approximated FIR filter corresponding to Hₖⱼ(z) which is defined according to equation 23:

$${H}_{kj} ( z ) = \frac{{\hat{S}}_{kj} ( z )}{1 - {C}_{j} ( z )} \qquad ( 23 )$$

Thus Xₖⱼ(z), the z-transform of xₖⱼ[n], can be written according to equation 24:

$${X}_{k j} ( z ) = X ( z ) {H}_{k j} ( z ) = \frac{X ( z ) {S}_{k j} ( z )}{1 - {C}_{j} ( z )} \qquad ( 24 )$$

### Case 2

A residual error shaping filter Fₖ(z) is defined at each node k, for shaping the spectral characteristics of the measured acoustic signal, or error signal, eₖ[n] at the node k according to its associated target spectral noise profile. The pseudo-error signal is then defined according to equation 25:

$${E}_{k}^{′} ( z ) = {E}_{k} ( z ) {F}_{k} ( z ) \qquad ( 25 )$$

and thus the objective of node k can be defined according to equation 26:

$${E}_{k} ( z ) = {E}_{k}^{′} ( z ) {{F}_{k} ( z )}^{- 1} \qquad ( 26 )$$

The adaptive filter coefficients can be updated according to equation 27:

$${w}_{k} [ n ] = {w}_{k} [ n - 1 ] - 2 μ {\sum }_{j = 1}^{K} {ϰ}_{kj} [ n ] {e}_{j}^{′} [ n ] \qquad ( 27 )$$

where xₖⱼ[n] is the vector containing the last l_{w} time instances of xₖⱼ[n]=x[n]*qₖⱼ[n], where qₖⱼ[n]=ŝₖⱼ[n]*fⱼ[n], being fⱼ[n] the inverse Z-Transform of F_j(z).

Therefore Xₖⱼ(z), the z-transform of xₖⱼ[n], can be written according to equation 28:

$${X}_{kj} ( z ) = X ( z ) {Q}_{kj} ( z ) = X ( z ) {\hat{S}}_{kj} ( z ) {F}_{j} ( z ) \qquad ( 28 )$$

### Updating the Adaptive Filter Coefficients in a Centralized Processing Scheme

Define w[n] as a global l_{w}.K-tap adaptive filter obtained by stacking all wₖ for all nodes k. w[n] can then be updated as follows:

For case 1, updated according to equation 29:

$$w [ n ] = w [ n - 1 ] - 2 μ {\sum }_{j = 1}^{K} {ϰ}_{j} [ n ] {e}_{j}^{′} [ n ] \qquad ( 29 )$$

where xⱼ[n] is a l_{w}.K-dimensional vector according to equation 30:

$${ϰ}_{j} [ n ] = [ \begin{matrix}{ϰ}_{1 j} [ n ] \\ ⋮ \\ {ϰ}_{Kj} [ n ]\end{matrix} ] \qquad ( 30 )$$

where the l_{w}-dimensional vector xₖⱼ[n] contains the last l_{w} time instances of xₖⱼ[n]=x[n]*hₖⱼ[n]. In this case, the z-transformed equivalent Xₖⱼ(z) is written according to equation 31:

$${X}_{kj} ( z ) = X ( z ) {H}_{kj} ( z ) = X ( z ) \frac{{\hat{S}}_{kj} ( z )}{1 - {C}_{j} ( z )} \qquad ( 31 )$$

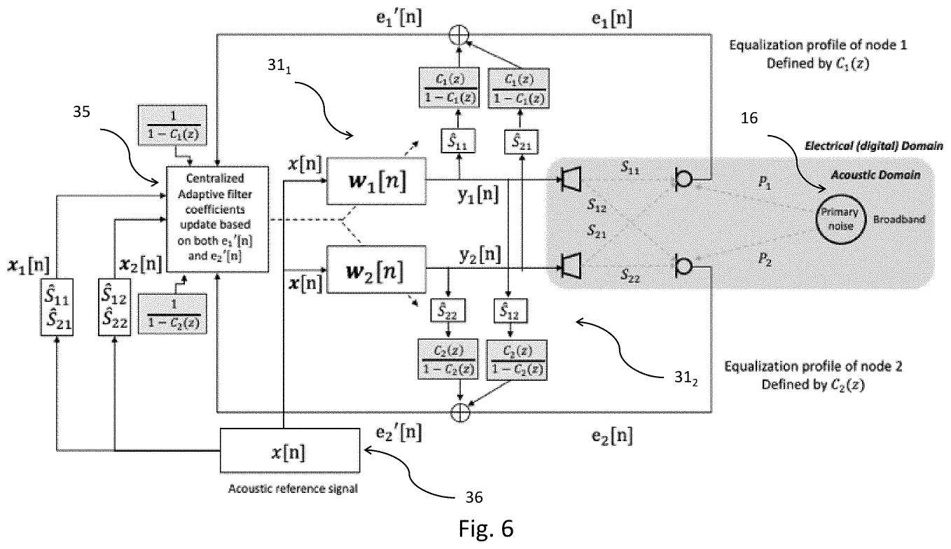

The signals sent and received in this scheme are shown in FIG. 6.

For case 2, updated according to equation 32:

$$w [ n ] = w [ n - 1 ] - 2 μ {\sum }_{j = 1}^{K} {ϰ}_{j} [ n ] {e}_{j}^{′} [ n ] ] \qquad ( 32 )$$

where xⱼ[n] is the l_{w}.K-dimensional vector according to equation 33:

$${ϰ}_{j} [ n ] = [ \begin{matrix}{ϰ}_{1 j} [ n ] \\ ⋮ \\ {ϰ}_{Kj} [ n ]\end{matrix} ] \qquad ( 33 )$$

where the l_{w}-dimensional vector xₖⱼ[n] contains the last l_{w} time instances of xₖⱼ[n]=x[n]* qₖⱼ[n]. The z-transformed equivalent Xₖⱼ(z) is written according to equation 34:

$${X}_{kj} ( z ) = X ( z ) {Q}_{kj} ( z ) = X ( z ) {\hat{S}}_{kj} ( z ) {F}_{j} ( z ) \qquad ( 34 )$$

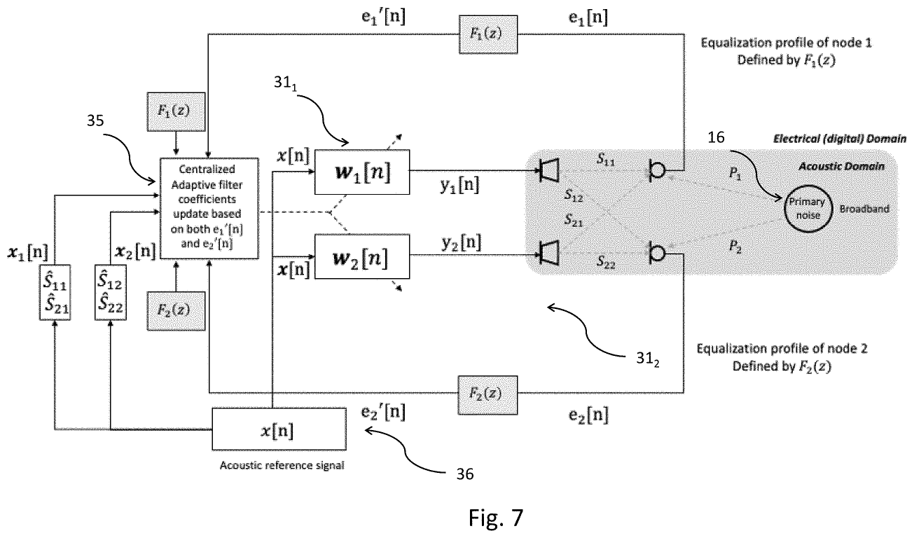

The signals sent and received in this scheme are shown in FIG. 7.

### Updating the Adaptive Filter Coefficients in a Distributed Processing Scheme

The adaptive filters of equations 22 and 27 can be split up for calculation in the distributed scheme, such that each node j can update the j-th term of the sum without needing to receive the pseudo-error signal from another node.

Define w^{j}[n] as the local version of the global filter w[n] at time instance n, updated at the j-th node. Then the adaptive filter coefficients can be updated according to equation 35:

$${w}^{j} [ n ] = {w}^{j - 1} [ n ] - 2 μ {x}_{j} [ n ] {e}_{j}^{′} [ n ] \qquad ( 35 )$$

where w⁰[n]=w^{K}[n−1]=w[n−1].

This applies to both Case 1 and Case 2, the only difference being in the definition of xⱼ[n] in each case.

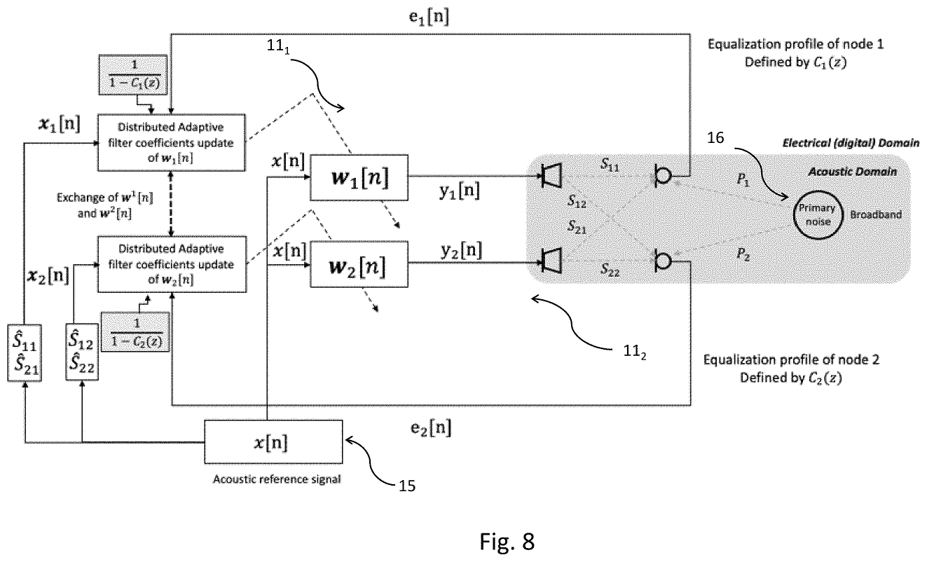

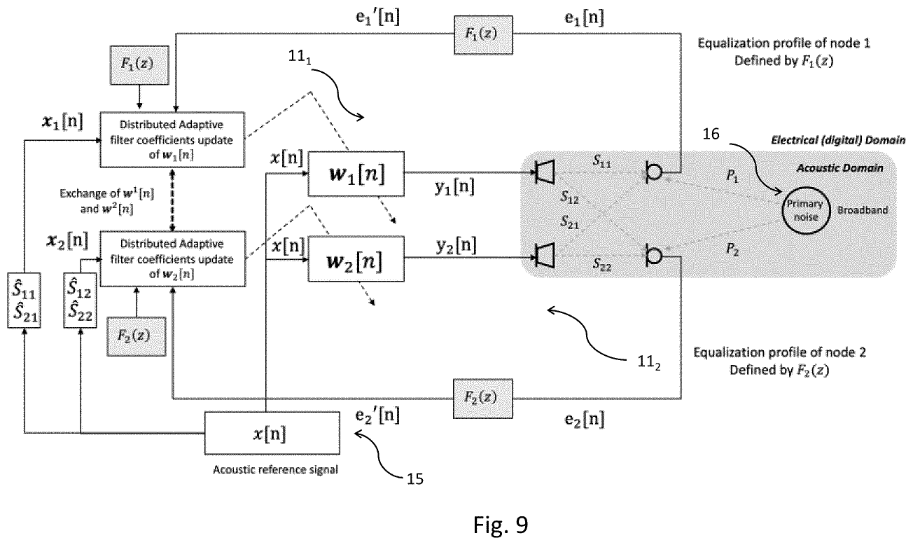

The signals sent and received in this scheme are shown in FIG. 8 for Case 1, and FIG. 9 for Case 2.

### Multiple Reference Signals

Methods according to embodiments hereof can include receiving one or more different reference signals. If more than one reference signal is received, for example in a car where a periodic reference signal may be received which is associated with car engine noise and a broadband reference signal may be received which is associated with wind or tyre noise, then a method as described hereinbefore can be carried out separately for each reference signal, and the resulting output acoustic signals in each case can be summed for each node before being provided to the acoustic actuator of that node.

### Automatic Active Noise Cancellation (AAMC)

Methods according to embodiments hereof can take advantage of the masking properties of an audio signal such as a speech or music signal, which is desired to be heard by a user, for masking of undesirable background noise.

Referring to FIG. 9a, when a noise cancellation profile is desired to be produced, a hearing threshold, or audibility threshold, model can be used as the output spectral profile.

Referring to FIG. 9b, when a noise equalization profile is desired to be produced, the output spectral profile can take into account a hearing threshold profile.

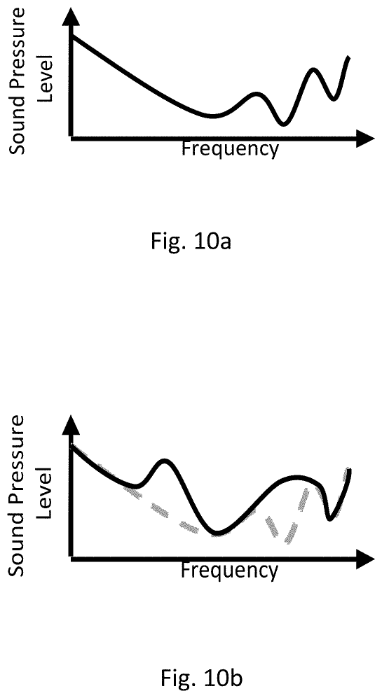

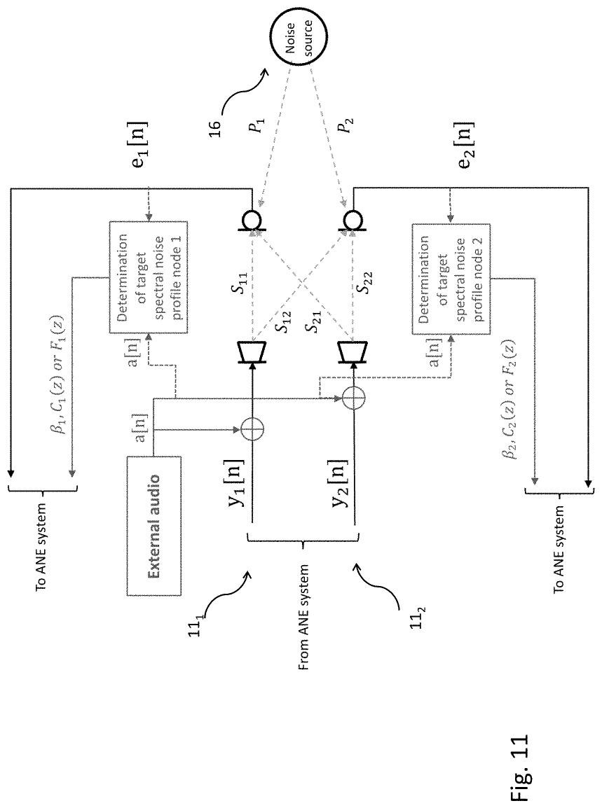

An audio signal such as a speech or music signal emitted by the loudspeaker of a node is denoted as a[n]. Referring to FIG. 10, a block diagram of an active noise control system according to embodiments hereof is shown which is similar to that of FIG. 5 and includes the playback of audio signals. The audio signal aₖ[n] received at a node k can be expressed in terms of the original audio signal filtered by the secondary paths between each node j and the node k under consideration, according to equation 36:

$${a}_{k} [ n ] = a [ n ] * {\sum }_{j = 1}^{K} {s}_{jk} [ n ] \qquad ( 36 )$$

assuming that every node is emitting the original audio signal a[n] at the same level. The frequency response Aₖ(e^{jω}) of the audio signal at node k can be expressed according to equation 37:

$${A}_{k} ( {e}^{j ω} ) = A ( {e}^{j ω} ) {\sum }_{j = 1}^{K} {S}_{jk} ( {e}^{j ω} ) \qquad ( 37 )$$

The objective signal of each node k, for the periodic and broadband noise cases, is as follows:

### Periodic Noise

The objective of each node k at frequency f is expressed according to equation 38:

$${E}_{k} ( {e}^{j {ω}_{i}} ) = {β}_{{k}_{i}} {D}_{k} ( {e}^{j {ω}_{i}} ) + {A}_{k} ( {e}^{j {ω}_{i}} ) , i = 1 , 2 , … , I \qquad ( 38 )$$

The coefficients βₖ_{ᵢ} in this equation will be calculated such that the noise remains below the masking threshold of the received audio signal, or below the audibility threshold if the masking threshold at frequency fᵢ is smaller than the audibility threshold. The masking threshold indicates the power level below which a noise signal is masked by the audio signal. The masking threshold of a complex sound is a subjective effect and there is no standard procedure for its calculation. For example, the masking threshold can be determined using a psychoacoustic masking model, for example as described in EP2284831. Based on fundamental properties of the human auditory system (e.g., frequency group creation and signal processing in the inner ear, simultaneous and temporal masking effects in the frequency-domain and the time-domain), a model can be produced to indicate which acoustic signals or which different combinations of acoustic signals are audible and inaudible to a person with normal hearing. The used masking model may be based on, e.g., the so-called Johnston Model or the ISO-MPEG-1 model (see, e.g., MPEG 1, “Information technology—coding of moving pictures and associated audio for digital storage media at up to about 1,5 Mbit/s—part 3: Audio,” ISO/IEC 11172-3:1993; K. Brandenburg and G. Stoll, “ISO-MPEG-1 audio: A generic standard for coding of high-quality digital audio,” Journal Audio Engineering Society, pp. 780-792, October 1994; T. Painter and A. Spanias, “Perceptual coding of digital audio,” Proc. IEEE, vol. 88, no. 4, pp. 451-513, April 2000).

Denoting the masking threshold of Aₖ(e^{jω}^{ᵢ}) as Ãₖ(e^{jω}^{ᵢ}), the coefficients βₖ_{ᵢ} can be calculated according to equation 39:

$${β}_{{k}_{i}} = {F}_{k} \frac{{\tilde{A}}_{k} ( {e}^{j {ω}_{i}} )}{\vert {D}_{k} ( {e}^{j {ω}_{i}} ) \vert} , i = 1 , 2 , … , I \qquad ( 39 )$$

where 0<Fₖ<1 is a gain term which aims to ensure that the sound pressure level of the noise is always under the masking threshold of the audio signal at each node k. If the βₖ_{ᵢ} so obtained are smaller than the audibility threshold, then the system will use these values, as is shown in the left branch of FIG. 9.

In practice, the value of the noise Dₖ in equation 35 has to be estimated at each node as \hat{D}ₖ(e^{jω}^{ᵢ}). This is achievable as each node knows 1) the frequency profile of its own audio signal Aₖ(e^{jω}^{ᵢ}) and 2) the contribution of all the secondary signals arriving at node k, given by Σⱼ₌₁^{K}yⱼ[n]*ŝⱼₖ[n]. Therefore, \hat{D}ₖ(e^{jω}^{ᵢ}) can be estimated according to equation 40:

$${\hat{D}}_{k} ( {e}^{j {ω}_{i}} ) = {E}_{k} ( {e}^{j {ω}_{i}} ) - {\sum }_{j = 1}^{K} {Y}_{j} ( {e}^{j {ω}_{i}} ) {\hat{S}}_{jk} ( {e}^{j {ω}_{i}} ) - {A}_{k} ( {e}^{j {ω}_{i}} ) , i = 1 , 2 , … , I \qquad ( 40 )$$

### Broadband Noise

In this case the audio signal Aₖ(e^{jω}^{ᵢ}) available at each node is the same as for the periodic noise, but the objective is different. For Case 1 as described hereinbefore, the objective signal at the microphone of node k is according to equation 41:

$${E}_{k} ( z ) = {C}_{k} ( z ) {D}_{k} ( z ) + {A}_{k} ( z ) \qquad ( 41 )$$

and the filter Cₖ (z) is designed such that equation 42 is satisfied:

$$\vert {C}_{k} ( {e}^{jω} ) \vert = {F}_{k} \frac{{\tilde{A}}_{k} ( {e}^{jω} )}{\vert {D}_{k} ( {e}^{jω} ) \vert} , 0 < {F}_{k} < 1 \qquad ( 42 )$$

Equation 38 is applied only in those bands where the resulting values of |Cₖ(e^{jω})| are above the audibility threshold. Similar to the case of periodic noise, the noise arriving at the microphone k can be estimated as \hat{D}ₖ(e^{jω}).

For Case 2 as described hereinbefore, the objective signal at the microphone of node k is modified according to equation 43:

$${E}_{k} ( z ) = {E}_{k}^{′} ( z ) {{F}_{k} ( z )}^{- 1} + {A}_{k} ( z ) \qquad ( 43 )$$

It can be seen that the objective signal of node k expressed in equation 24 has a direct relation to the inverse of the shaping filter Fₖ(e^{jω}), but not to the primary noise signal Dₖ(z). Therefore, the design of the shaping filter has no closed-form solution but it is defined to accomplish a certain shaping profile based on the masking threshold of the audio signal Ãₖ(e^{jω}). The formulation of Fₖ(e^{jω}) is then expressed as the minimisation of a certain mean square error according to equation 44:

$${F}_{k} ( {e}^{jω} ) s . t . {min}_{{F}_{k} ( {e}^{jω} )} \{ \vert {E}_{k}^{′} ( {e}^{jω} ) {{F}_{k} ( {e}^{jω} )}^{- 1} \vert - {F}_{k} {\tilde{A}}_{k} ( {e}^{jω} ) \} , 0 < {F}_{k} < 1 \qquad ( 44 )$$

1. A method of active noise equalization in a system comprising a plurality of nodes, each node comprising at least one acoustic sensor and at least one acoustic actuator, and each node having an associated target spectral noise profile and an associated set of adaptive filter coefficients, the method comprising the steps of:
i) at each node, receiving a reference acoustic signal;
ii) at each node, generating an output acoustic signal based on the received reference acoustic signal and the associated set of adaptive filter coefficients for the node;
iii) at each node, receiving a measured acoustic signal for the node and computing a pseudo-error signal for the node in dependence upon the received measured acoustic signal and the target spectral noise profile associated with the node; and
iv) updating at least one adaptive filter coefficient in the set of adaptive filter coefficients for at least a first node comprised in the plurality of nodes, in dependence upon the pseudo-error signal associated with the first node, the reference acoustic signal, and at least one parameter received from at least one other node in the plurality of nodes which is dependent on the pseudo-error signal associated with the at least one other node.

2. The method according to claim 1, further comprising repeating at least steps ii) to iv).

3. The method according to claim 1, wherein receiving a reference acoustic signal comprises receiving the reference acoustic signal at the first node, and wherein determining at least one adaptive filter coefficient for at least the first node comprises receiving, at the first node, the at least one parameter dependent on the pseudo-error signal associated with at least one other node comprised in the plurality of nodes and determining, at the first node, the at least one adaptive filter parameter for the first node.

4. The method according to claim 3, further comprising sending, from the first node, at least one parameter dependent on the pseudo-error signal associated with the first node to at least one other node comprised in the plurality of nodes.

5. The method according to claim 2, wherein receiving a reference acoustic signal comprises receiving the reference acoustic signal at the first node, and wherein determining at least one adaptive filter coefficient for at least the first node comprises receiving, at the first node, the at least one parameter dependent on the pseudo-error signal associated with at least one other node comprised in the plurality of nodes and determining, at the first node, the at least one adaptive filter parameter for the first node.

6. The method according to claim 5, further comprising sending, from the first node, at least one parameter dependent on the pseudo-error signal associated with the first node to at least one other node comprised in the plurality of nodes.

7. The method according to claim 1, wherein the at least one parameter dependent on the pseudo-error signal associated with a node comprises at least one adaptive filter coefficient for the associated node.

8. The method according to claim 1, wherein receiving the reference acoustic signal comprises receiving the reference acoustic signal at a central processing unit, and wherein determining the at least one adaptive filter coefficient for generating an output acoustic signal for at least the first node comprises receiving, at the central processing unit, the pseudo-error signal associated with the first node and the pseudo-error signal associated with the at least one other node comprised in the plurality of nodes, and determining, at the central processing unit, the at least one adaptive filter coefficient for the first node.

9. The method according to claim 2, wherein receiving the reference acoustic signal comprises receiving the reference acoustic signal at a central processing unit, and wherein determining the at least one adaptive filter coefficient for generating an output acoustic signal for at least the first node comprises receiving, at the central processing unit, the pseudo-error signal associated with the first node and the pseudo-error signal associated with the at least one other node comprised in the plurality of nodes, and determining, at the central processing unit, the at least one adaptive filter coefficient for the first node.

10. The method according to claim 1, wherein the at least one parameter dependent on the pseudo-error signal comprises the pseudo-error signal.

11. The method according to claim 8, further comprising providing the at least one adaptive filter coefficient for the first node to the first node.

12. The method according to claim 9, further comprising providing the at least one adaptive filter coefficient for the first node to the first node.

13. The method according to claim 1, wherein the target spectral noise profile is a noise cancellation profile based upon an auditory threshold model, optionally wherein the noise cancellation profile is specified by a user at a node.

14. The method according to claim 1, wherein the target spectral noise profile is a noise equalization profile, optionally wherein the noise equalization profile is specified by a user at a node.

15. The method according to claim 1, wherein the measured acoustic signal comprises a desired audio signal and a noise signal, and wherein the target spectral noise profile is a noise equalization profile determined based on auditory masking of the audio and the noise signals.

16. The method according to claim 1, wherein the received reference acoustic signal comprises a periodic noise signal and/or a broadband noise signal.

17. A computer program product comprising instructions which, when the program is executed by a computer, cause the computer to carry out a method of active noise equalization in a system comprising a plurality of nodes, each node comprising at least one acoustic sensor and at least one acoustic actuator, and each node having an associated target spectral noise profile and an associated set of adaptive filter coefficients, the method comprising the steps of:
i) at each node, receiving a reference acoustic signal;
ii) at each node, generating an output acoustic signal based on the received reference acoustic signal and the associated set of adaptive filter coefficients for the node;
iii) at each node, receiving a measured acoustic signal for the node and computing a pseudo-error signal for the node in dependence upon the received measured acoustic signal and the target spectral noise profile associated with the node; and
iv) updating at least one adaptive filter coefficient in the set of adaptive filter coefficients for at least a first node comprised in the plurality of nodes, in dependence upon the pseudo-error signal associated with the first node, the reference acoustic signal, and at least one parameter received from at least one other node in the plurality of nodes which is dependent on the pseudo-error signal associated with the at least one other node.

18. An apparatus for active noise equalization comprising a plurality of nodes, each node comprising at least one acoustic sensor and at least one acoustic actuator, and each node having an associated target spectral noise profile and an associated set of adaptive filter coefficients, wherein each node is configured:
to receive a reference acoustic signal;
to generate an output acoustic signal based on the received reference acoustic signal and the associated set of adaptive filter coefficients for the node;
to receive a measured acoustic signal for the node and compute a pseudo-error signal for the node in dependence upon the received measured acoustic signal and the target spectral noise profile associated with the node; and
to update at least one adaptive filter coefficient in the set of adaptive filter coefficients for the node, in dependence upon the pseudo-error signal associated with the node, the reference acoustic signal, and at least one parameter received from at least one other node in the plurality of nodes, which is dependent on the pseudo-error signal associated with the at least one other node.

19. An apparatus for active noise equalization, the apparatus comprising:
a plurality of nodes, each node comprising at least one acoustic sensor and at least one acoustic actuator, and each node having an associated target spectral noise profile and an associated set of adaptive filter coefficients; and
a central processing unit in communication with each of the nodes in the plurality of nodes, wherein the central processing unit is configured to receive a reference acoustic signal;
wherein each node is configured:
to generate an output acoustic signal based on the received reference acoustic signal and the associated set of adaptive filter coefficients for the node;
to receive a measured acoustic signal for the node and compute a pseudo-error signal for the node in dependence upon the received measured acoustic signal and the target spectral noise profile associated with the node; and
to provide the pseudo-error signal for the node to the central processing unit;
wherein the central processing unit is configured to update at least one adaptive filter coefficient in the set of adaptive filter coefficients for at least a first node comprised in the plurality of nodes, in dependence upon the pseudo-error signal associated with the first node, the reference acoustic signal, and at least one parameter received from at least one other node in the plurality of nodes which is dependent on the pseudo-error signal associated with the at least one other node.

20. The method according to claim 2, wherein the at least one parameter dependent on the pseudo-error signal comprises the pseudo-error signal.
